(19) United States
(12) Patent Application Publication
(10) Pub. No.: US 2019/0234853 A1
(43) Pub. Date: Aug. 1, 2019

(54) HOLOGRAPHIC CHARACTERIZATION USING HU MOMENTS

(71) Applicant: SPHERYX, INC., New York, NY (US)

(72) Inventors: David B. RUFFNER, New York, NY (US); Laura PHILIPS, New York, NY (US); Fook Chiong CHEONG, New York, NY (US)

(21) Appl. No.: 16/328,196

(22) PCT Filed: Aug. 24, 2017
(86) PCT No.: PCT/US17/48496

§ 371 Date: Feb. 25, 2019

Related U.S. Application Data
(60) Provisional application No. 62/379,998, filed on Aug. 26, 2016.

(51) Int. Cl. G01N 15/02; G01N 15/14; G03H 1/00; G03H 1/08

(52) U.S. Cl. CPC G01N 15/0227; G01N 15/1463; G03H 2001/0033; G03H 1/0866; G03H 1/0005

(57) ABSTRACT

Holographic microscopy analysis system and methods for determining morphology of a particle in a sample. A bright-field reconstruction image is generated from a recorded hologram from a holographic microscopy system. Morphology of particles imaged by the system may be determined. Hu moments are calculated, either from the hologram or from the bright-field reconstruction, or both, to provide an indication of morphology.

### BACKGROUND OF THE INVENTION

Silicone oil is a common contaminant in protein based medicine that can come from syringe lubrication, gaskets, or vial septa. Although not particularly problematic on its own, silicone oil droplets can be misidentified as protein aggregates which can present risks to patients and lower medicine effectiveness. Furthermore silicone emulsion droplets can induce protein aggregation. To appropriately address these issues, one must be able to distinguish protein aggregates from silicone oil emulsion droplets. Other contaminants to consider may be intrinsic or extrinsic. Intrinsic contaminants include, but are not limited to, silicone oil, air bubbles, excipients added for stabilization during the formulation development. Extrinsic contaminants include, but are not limited to, dust, glass shards, rubber particulate matter, bacteria.

Both protein aggregates and silicone oil emulsion droplets (and other contaminants can) have similar size in the micron-scale range and therefore are impossible to distinguish with many particle characterization techniques such as static light scattering, dynamic light scattering, light obscuration, and Coulter counters. Two techniques used for distinguishing protein aggregates from silicone oil emulsion droplets are microflow imaging (MFI) and resonant mass measurement (RMM). MFI works by imaging particles as they flow through a microfluidic channel. These images can be used to distinguish particles based on properties like aspect ratio and contrast. It works well for large particles but has difficulty distinguishing particles smaller than a few microns in diameter due to diffraction. RMM also flows particles through a microfluidic channel but measures the buoyant mass of each particle as it flows through the channel. Positively buoyant particles like silicone oil droplets thus can be distinguished from negatively buoyant protein aggregates, however, it only works on particles smaller than 5 μm. In addition, RMM only measures one property of the particle.

MFI has limitations on its sensitivity for particles less than 5 um in diameter. FIG. 16B shows that MFI detects fewer ETFE particles than those counted by holographic microscopy. These particles, which are made from rubber, are designed to be a good proxy for protein aggregates.

### SUMMARY OF THE INVENTION

In some embodiments, Hu's moments are used in combination with holographic microscopy for identification of materials in a sample.

In some embodiments, asymmetric and symmetric particles can be distinguished using 3D Rayleigh-Sommerfeld coupled with deconvolution followed by numerical integration along a single axis from single holograms measured using holographic microscopy. 3D Rayleigh-Sommerfeld reconstruction results in a 3D image of the particle under examination. Rayleigh-Sommerfeld theory can be used to reconstruct the 3D light field created by a scattering particle. From the 3D light field, the positions of all of the scattering centers within the particle are determined, using deconvolution methods. The scattering centers are used to construct the 3D structure of the particle. Integration along a single axis creates a 2D image that is an accurate representation of a bright field image with higher resolution than is possible for bright field images of sub-visible particles.

Another embodiment relates to a method for determining a particle's morphology. The method comprises flowing a sample through a microfluidic channel. A laser beam is interacted with the sample. The laser beam is scattered off the sample to generate a scattered portion. An interference pattern is generated from an unscattered portion of the collimated laser beam and the scattered portion. The interference pattern is magnified with an objective lens. The interference pattern is recorded for subsequent analysis. A scattering function is applied to calculate a hologram and fitting the recorded interference pattern to the calculated hologram. An estimate of the specimen's refractive index and radius is determined from the fitted calculated holograms. Hu moments are determined for the recorded interference pattern.

Another embodiment relates to a computer-implemented machine for determining a particle's morphology. The machine comprises a processor, a holographic microscopy system, a sample stage for receiving and flowing a plurality of particles; and a tangible computer-readable medium operatively connected to the processor and the holographic microscopy system and including computer code. The computer code is configured to: flow a particle through a laser beam in a microfluidic channel in the sample stage; record an interference pattern of the laser beam and the particle; reconstruct a three-dimensional light field by applying Rayleigh-Sommerfeld analysis; deconvolute the three-dimensional light field to determine scattering centers within the particle; and integrate along a single axis and constructing a two-dimensional image of the particle.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1A illustrates one embodiment of the principle of holographic microscopy characterization (“HMC”) applied to monitoring protein aggregation. Holographic images of colloidal particles flowing down a microfluidic channel are compared with predictions of the Lorenz-Mie theory of light scattering to obtain each particle's diameter dₚ, and refractive index, nₚ. Each point in the scatter plot represents the properties of a single particle from a typical sample of human IgG aggregated by sonication. The measured and computed holograms, shown as grayscale images, correspond to the particular data point indicated. Colors indicate the relative density of measurements, p(dₚ, nₚ), with a peak at dₚ=2.7 μm and nₚ=1.339.

FIG. 1B illustrates an HMC instrument.

FIGS. 2A-2B show holographic characterization data for two types of protein aggregates. FIG. 2A: Bovine serum albumin (BSA) complexed with poly (allylamine hydrochloride) (PAH) in Tris buffer. FIG. 2B: Bovine insulin aggregated with 0.1M NaCl.

FIGS. 3A-3C show differentiation of protein aggregates from silicone oil droplets by Total Holographic Characterization. FIG. 3A: Distribution of properties of aggregates of human IgG. FIG. 3B: Distribution of properties of silicone oil droplets in water. FIG. 3C: Properties of a mixture of IgG aggregates and oil droplets. The two sub-populations are clearly resolved.

FIGS. 4A-4C show Influence of pH on aggregation of oxytocin. FIG. 4A shows Oxytocin does not aggregate appreciably at pH 2. FIG. 4B shows the impact of increasing the pH to 9 induces aggregation. The intensity bar indicates relative density of measurements, p(dₚ, nₚ). FIG. 4C shows the number of oxytocin aggregates as a function of pH, showing steady increase with increasing pH.

FIGS. 5A-5D show the influence of sonication on aggregation of human IgG and oxytocin. FIG. 5A shows results for Human IgG and FIG. 5B shows results for oxytocin before sonication. FIG. 5C shows results for Human IgG and FIG. 5D shows results for oxytocin after sonication for 1 h. In both cases, sonication promotes formation of smaller, denser aggregates. Data points are colored by density of measurements, with lighter colors representing higher density.

FIG. 6 shows one embodiment of an instrument for measuring particles.

FIG. 7 shows one embodiment of a microfluidic chip for use with the instrument of FIG. 6.

FIG. 8 shows one embodiment of a multi-sample carousel cartridge for rapid assaying.

FIG. 9 shows measured velocity v(z) of colloidal particles moving down microfluidic channels as a function of height, z, above the focal plane. Data are shown for one channel with a height of 50 μm and another with a height of 100 μm. The anticipated parabolic profile for pressure-driven channel flow is clearly resolved.

FIGS. 10A-10B show holographic characterization of fractal colloidal aggregates. FIG. 10A shows the distribution of the effective radius, a*ₚ, and the effective refractive index, n*ₚ, of model fractal aggregates composed of monodisperse polystyrene spheres. FIG. 10B shows the same data rescaled to emphasize the fractal structure of this population of aggregates. The sloped line is the prediction of the effective sphere model for a fractal dimension D=1.7. FIG. 10C shows a scanning electron microscope image of a typical aggregate. Scale bar: 1 μm.

FIGS. 11A-11B illustrate a representation of shapes that will yield zero first Hu moments (FIG. 11A) and non-zero first Hu moments (FIG. 11B). Hu moments are invariant with respect to rotation, scale and translation. The zeroth order Hu moment represents the scaled moment of inertia. The first Hu moment is related to the circular symmetry of the image. Protein aggregates that are non-spherical should have non-zero first order Hu moments.

FIG. 12 shows a comparison of binary images of holograms measured of spherically symmetric silicone oil droplets and aspherical protein aggregates.

FIG. 13 is a plot of index of refraction (n) versus size (d) for a sample consisting of a mixture of silicone oil droplets and protein aggregates in which there is overlap of the data from the silicone oil droplets and the protein aggregates. The size and index of refraction as determined using HMC are insufficient to distinguish the two species in the region of overlap. The color of the points in the plot represents the magnitude of the first Hu moment of the holograms. Blue points represent particles with holograms that have first order Hu moments close to or equal to zero. Orange and yellow points represent particles with holograms that have first order Hu moments that are greater than zero.

FIG. 14 shows a plot of index of refraction (n) versus size (d) for a sample of Human IgG. For 2 points, the holograms of the particles are show as well as the holographic flow imaging reconstruction of a two dimensional image of the particle. The image of the smaller, higher index of refraction particle shows a more symmetric particle, while the larger lower index particle's image reveals significant detail about structure of a highly asymmetric particle.

FIGS. 15A-15B show several holograms and two dimensional images from holographic flow imaging reconstructions. FIG. 15A contains data from a sample of silicone oil emulsion droplets. In this panel the top images are holograms measured using HMC. Directly below each hologram is the two dimensional image reconstructed from the hologram using holographic flow imaging (“HFI”). Below the HFI images are the first Hu moments for each image. FIG. 15B contains data from a sample of IgG protein aggregates. Again, the top images in this panel are holograms measured using HMS, directly below each hologram is the two dimensional image reconstructed using holographic flow imaging and below the HFI image are the first Hu moments.

FIG. 16A shows a plot demonstrating accurate concentration measurement for 1.5 um polystyrene beads at concentrations of 10³-10⁷ particles/mL using HMC.

FIG. 16B shows a comparison of MFI and HMC concentration measurements of model protein aggregates developed by NIST composed of ETFE. The NIST model particles are a range of sizes that simulate the size distribution of protein aggregates. The plot represents the concentration as a function of the size of particles in bins of 1-2 um, 2-4 um, 4-8 um and 8-12 um. The MFI and HMC concentration measurements agree for particles >5 um. For sizes less than 5 um HMC is more sensitive and can detect many more particles than MFI.

FIG. 17 illustrates one method of generating a HFI image.

FIG. 18 shows two holograms and their HFI images, on the left a symmetric silicone oil emulsion droplet and on the right a non-spherical protein aggregate.

FIG. 19 illustrates a computer system for use with certain implementations.

### DETAILED DESCRIPTION OF THE PREFERRED EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

Holographic Microscopy Characterization (HMC) can distinguish of protein aggregates and silicone oil droplets down to smaller sizes than MFI, and it returns more information than RMM. HMC is described further in “Tracking and Characterizing Particles with Holographic Video Microscopy,” U.S. Pat. No. 8,791,985, July 2014; “Sorting Colloidal Particles into Multiple Channels with Optical Forces: Prismatic Optical Fractionation,” U.S. Pat. No. 8,766,169, July 2014; “Holographic Microfabrication and Characterization System for Soft Matter and Biological Systems,” U.S. Pat. No. 8,431,884, April 2013; “Holographic Microscopy of Holographically Trapped Three-Dimensional Nanorod Structures,” U.S. Pat. No. 8,331,019, December 2012; S.-H. Lee, D. G. Grier, “Holographic Microscopy of Holographically Trapped Three-Dimensional Structures,” U.S. Pat. No. 7,839,551, November 2010; each of which is incorporated herein by reference.

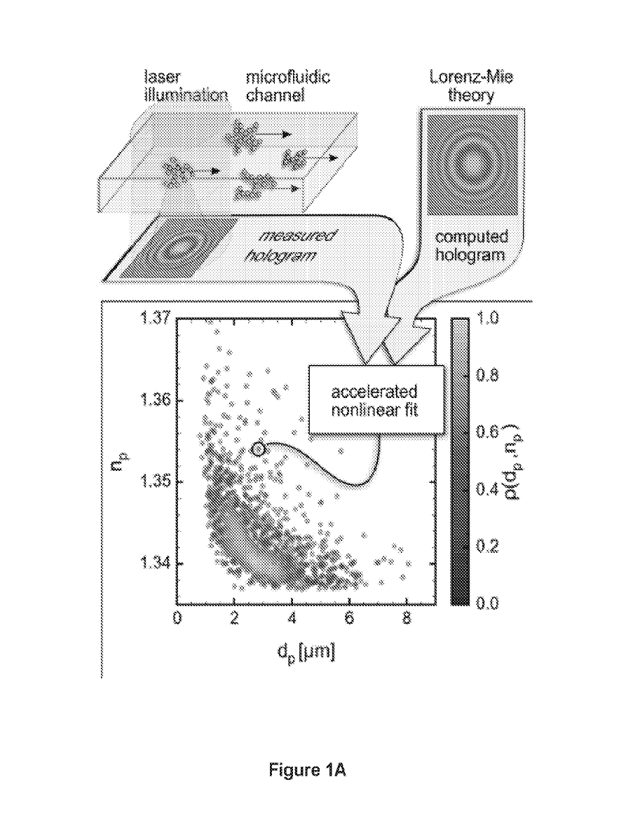

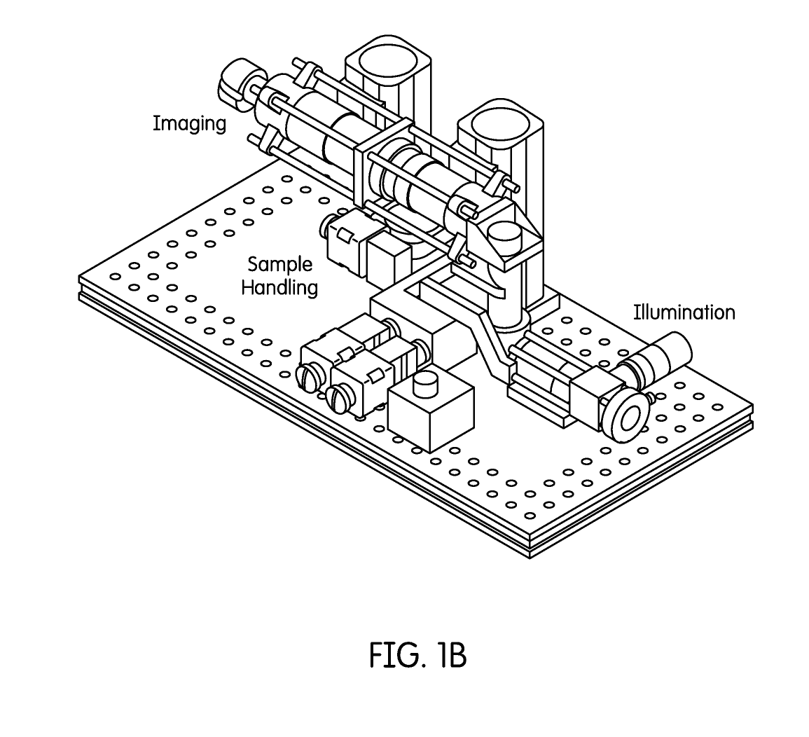

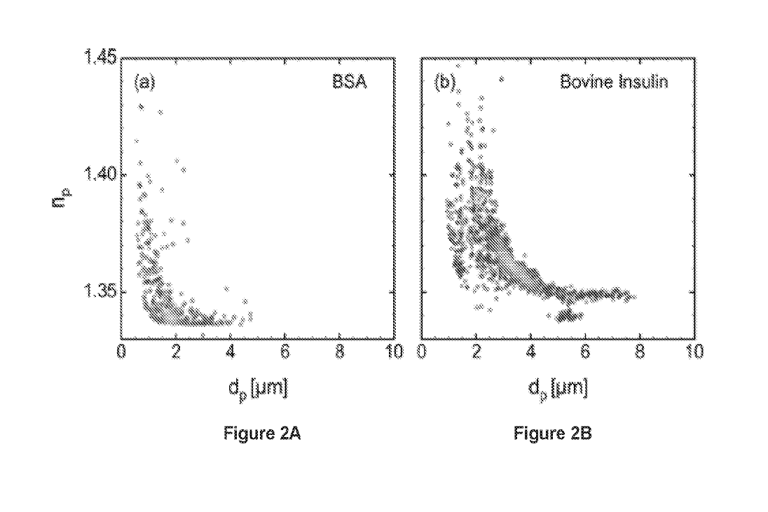

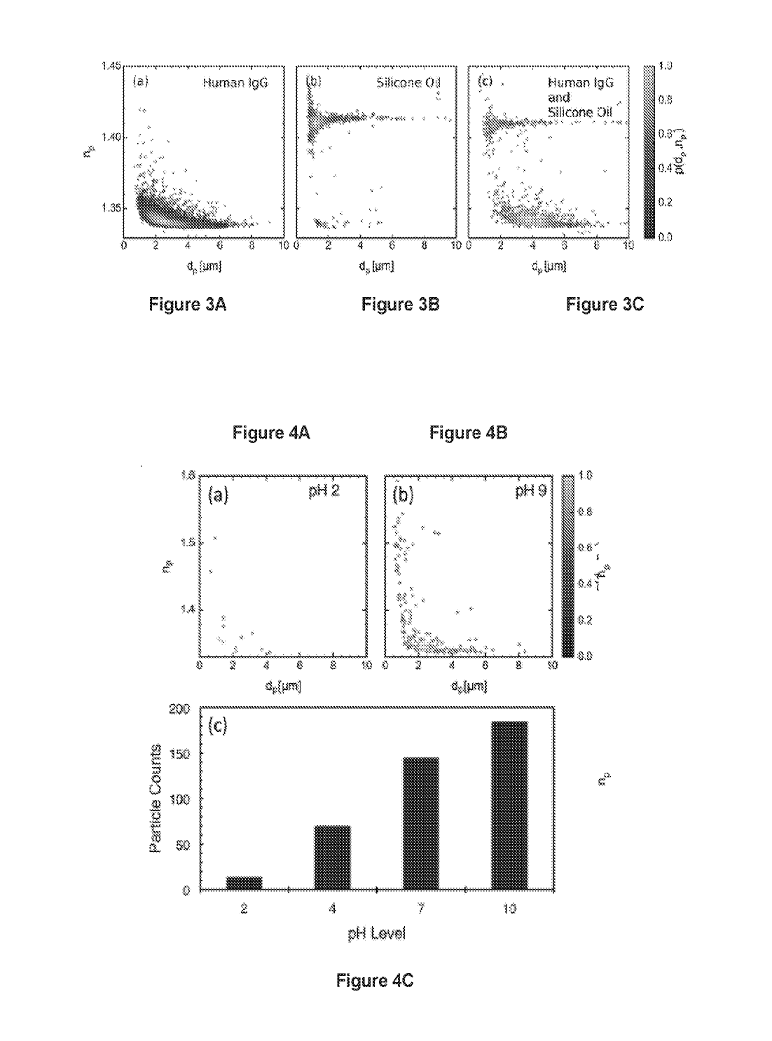

HMC, in general terms, works by flowing particles down a microfluidic channel and illuminating with coherent illumination. FIG. 1B shows one embodiment of a setup for HMC. Light from a collimated laser beam illuminates a sample within a microfluidic channel. An illuminated particle scatters some of that light to the focal plane of a microscope, where it interferes with the remainder of the beam. The microscope magnifies the resulting interference pattern and projects it onto the sensor of a video camera, which records its intensity. Multiple particles may generate holograms within the same “frame” of the video. The scattered light forms a hologram that contains detailed information about the particle. The hologram can be analyzed with Lorenz-Mie theory to get the size and refractive index of the particle. The refractive index gives information about the composition of the particle which can be used to distinguish particles even if they have the same size. The application of the exact Lorentz-Mie theory enables HMC to get accurate results down to smaller sizes than MFI. HMC has multiple dimensions of measurement—size, refractive index, and 3D position of each particle—compared to only buoyant mass measurement with RMM.

Holograms of colloidal spheres, such as the example in FIG. 1, take the form of concentric bright and dark circular rings. Irregularly shaped objects, such as protein aggregates, produce holograms with reduced radial symmetry. The degree of irregularity can be quantified by computing the Hu moment invariants of the holographic image, centered on each automatically detected feature. The relevant moments have values close to zero for symmetric patterns, and approach unity for very asymmetric features. They should be useful for distinguishing protein aggregates from more symmetric objects, such as silicone oil droplets, independent of other characteristics such as size and refractive index.

The combination of holographically measured size, refractive index and image moments for a given particle can be used as inputs to a classification scheme that identifies the object as a protein aggregate, a silicone oil droplet, or some other contaminant such as a bacterium, a glass shard or a fleck of rubber. This classification will be useful for assessing the concentrations of different species in suspension.

Moment analysis of a hologram does not inherently measure the morphology of the underlying particle. It is likely, however, that these metrics can be correlated with morphology. It has recently have demonstrated that the refractive index obtained by holographic characterization of irregularly branched aggregates can be interpreted with effective medium theory to estimate the aggregates' fractal dimension and therefore to characterize their morphology.

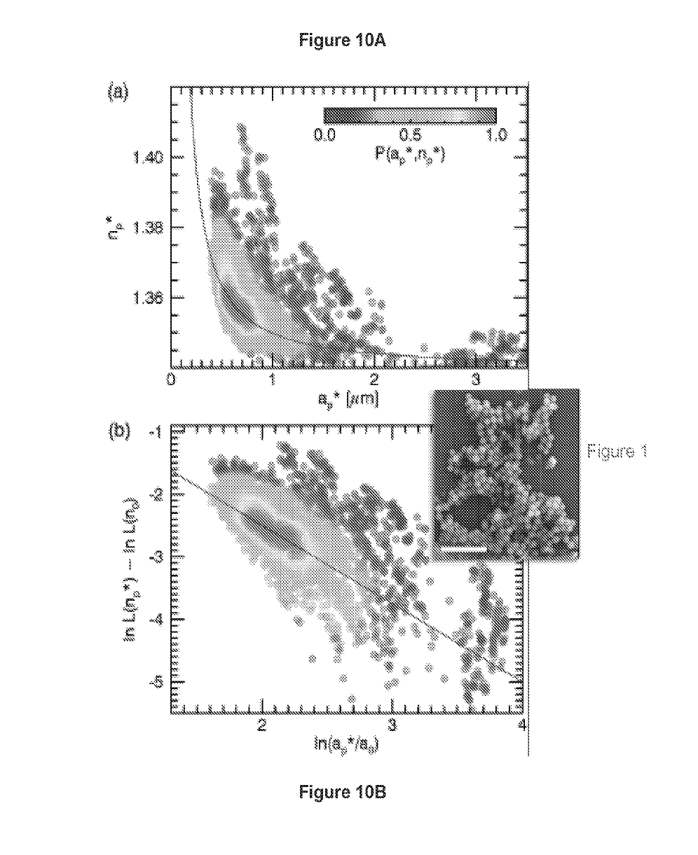

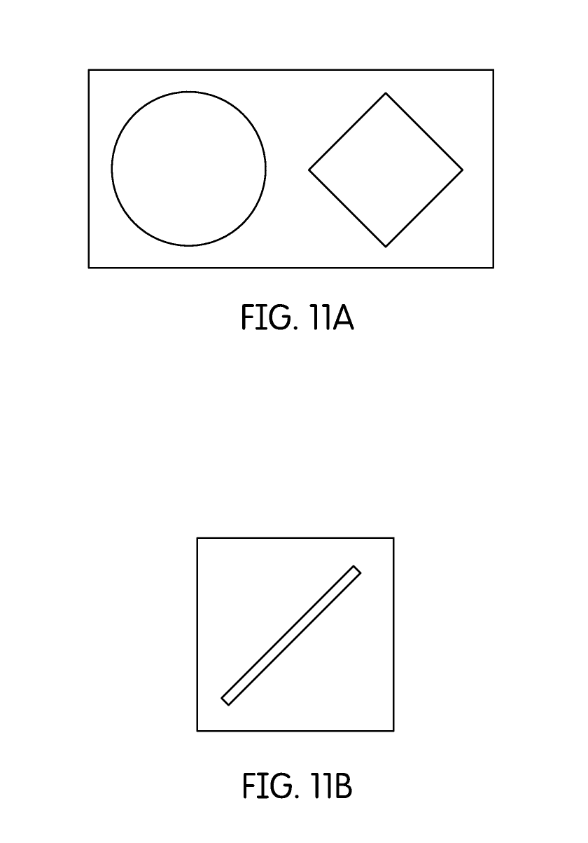

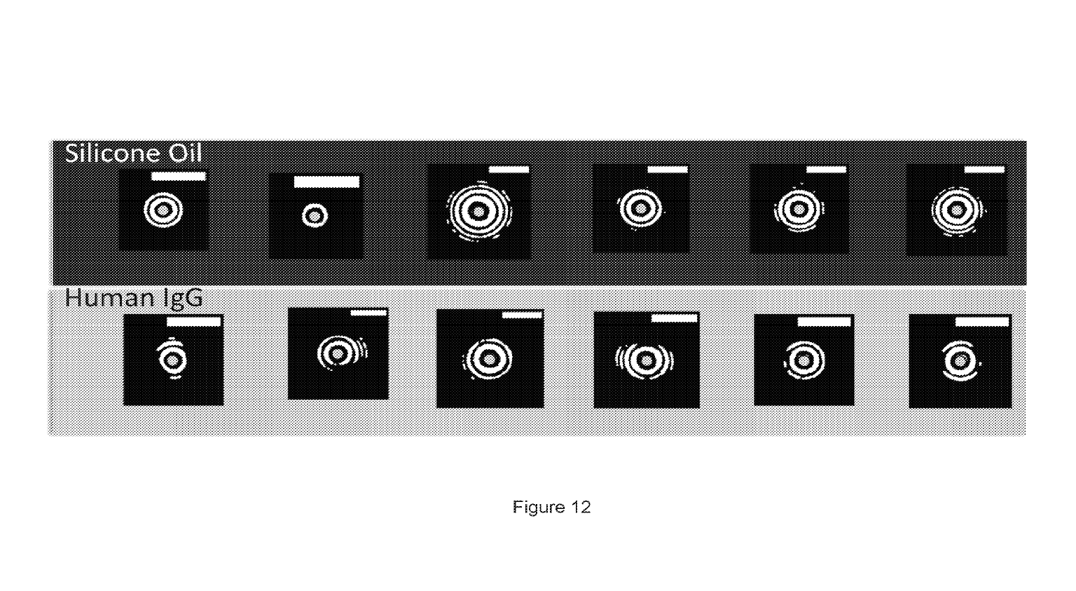

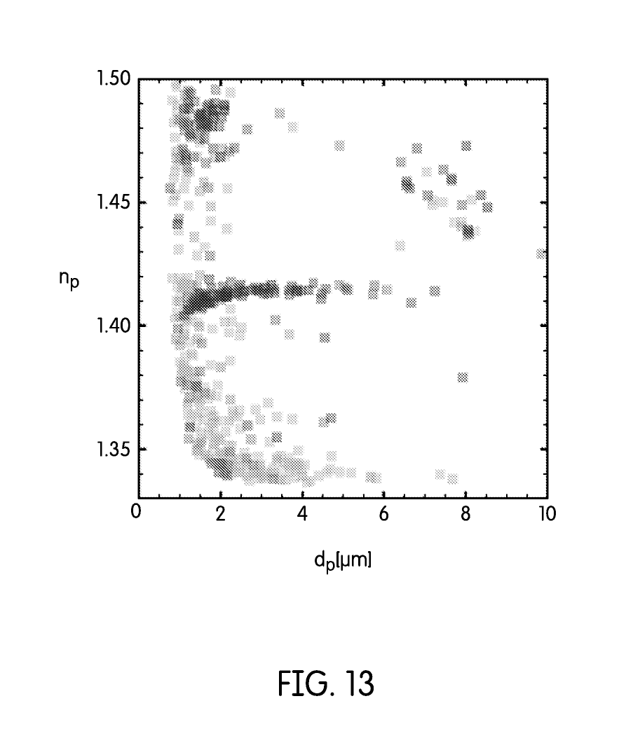

The data in FIG. 10A were obtained for fractal clusters of polystyrene nanospheres that were created through diffusion-limited cluster aggregation (DLCA). A scanning electron micrograph of a typical aggregate is shown in the inset. These irregularly-shaped aggregates were analyzed with high-speed Lorenz-Mie analysis under the effective-sphere approximation. The radius, a*ₚ, and refractive index, n*ₚ, obtained from these fits are interpreted to characterize the effective sphere enclosing both the fractal aggregate and also the low-index medium filling the pores between its branches.

Characterization data for fractal aggregates consistently fall along a downward sloping curve that also is observed for protein aggregates. The effective-sphere model for scale-invariant fractals then predicts that the effective refractive index will scale with the apparent size according to

lnL(n*p)=(D−3)ln(a*p/a₀)+lnL(n₀),

where L(n)=(n²−n²m)/(n²+2n²m) is the Lorentz-Lorenz factor for a substance of refractive index n in a medium of refractive index nm, and where a₀ and n₀ are the radius and refractive index of the constituent monomer particles, respectively. The aggregates analyzed in FIG. 10 have a₀=80 nm and n₀=1.59.

Rescaled according to this scaling prediction, the characterization data from FIG. 10A should fall along a straight line whose slope yields the clusters' characteristic fractal dimension D. The result, shown in FIG. 10B, yields a fractal dimension D=1.75, which is expected for DLCA.

Applying the same analysis to the data for BSA, BI, IgG and oxytocin suggests that all four types of protein aggregates are fractal, but with significantly different fractal dimensions.

BSA-PAH complexes consistently have fractal dimensions in the range D=1.1±0.1, suggesting that these are nearly linear aggregates with little branching. Bovine insulin consistently displays a higher fractal dimension, D=1.5±0.1, suggesting a higher degree of branching. The fractal dimension obtained for IgG, D=1.7±0.1, is as large as that of the polystyrene aggregates, and suggests that these protein clusters also grew via diffusion limited cluster aggregation.

Using standard holographic microscopy based techniques with non-regular particles mixed with regular particles yields the size, refractive index and porosity of an individual aggregate or contaminant particle typically with part-per-thousand precision and accuracy. Using these data to count and differentiate particles yields accurate concentration values for concentrations between 10³ particles/mL and 10⁷ particles/mL. However, present embodiments extend the capabilities to morphological information.

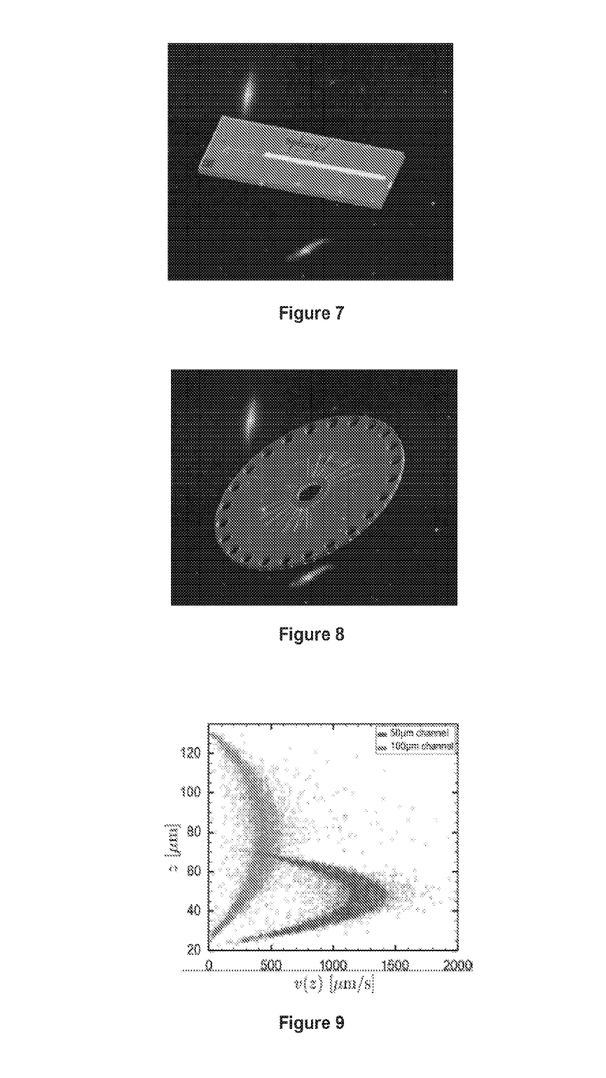

FIG. 6 illustrates one embodiment of a holographic characterization instrument. The instrument of FIG. 6 utilizes a microfluidic chip. One embodiment of a microfluidic chip is shown in FIG. 7. The comparatively large sample volume largely eliminates problems of clogging and fouling that can bedevil resonant mass measurement, particularly in heterogeneous real-world samples. Large resonant mass measurement sample cells have channels that are typically less than 10 μm×10 μm, compared to, in one embodiment, 50 μm×1000 μm for sample microfluidic chips. Analysis involves pipetting a 100 μL aliquot of sample into the reservoir on the left and then locking the chip into the instrument's sample stage. The sample is transported through a microfluidic channel to the on-chip waste reservoir by applying vacuum to a port at the end of the reservoir. One embodiment of an instrument features a mating vacuum manifold that is engaged by inserting the chip into the instrument. The sample never leaves the chip, minimizing chances for cross-contamination.

Existing HMC instruments require technicians to change each disposable microfluidic chip and generally is a very manual process. However, FIG. 8 illustrates an embodiment for fast automated sample characterization. This disposable multi-sample, 24-samples in one embodiment, carousel cartridge uses microfluidic channels arranged radially. Samples are loaded into reservoirs near the rim and rotated into place for measurement.

In one embodiment the cartridge has the same dimensions as a standard compact disk, and so can be managed and manipulated with time tested and cost-effective technology developed for consumer applications. A rotating turret will replace the single-slide sample mount in the beta instrument. Disks will be inserted into the turret and removed for disposal using standard transport mechanisms.

The disk's reservoirs will be accessible to robotic sample dispensers. Each reservoir in the carousel feeds into a microfluidic channel that resembles the single-sample channel from FIG. 8. The instrument's vacuum manifold mates with vacuum ports near the center of the disk and draws one sample at a time through the measurement volume. For example, in one embodiment, multiple parallel tracks on the same rectangular slide can be used. Further, another option is the repetitive loading of individual microfluidic chips that hold single samples. In each case, the sample is drawn through the sample-viewing region from the sample reservoir. A further embodiment alters the typical position of the microscope optics, positioning the microscope at a 90-degree rotation, such that the optical axis is horizontal and the sample flows vertically with the reservoir above the viewing region and the sample is pulled through the viewing region, similar to the horizontal arrangement, or by the force of gravity alone.

FIG. 10 presents the measured dependence of colloidal particles' speed, v(z), as a function of height, z, in two microfluidic channels, one of total height 50 μm, and the other 100 μm. Both measurements were performed on the same system. Particle-tracking data were obtained from the same holographic fits used to characterize the particles. The particles act as tracers for the fluid's velocity field in the microfluidic channel and thus map out the parabolic profile characteristic of pressure-driven Poiseuille flow. Different shear forces occur under different flow conditions. Shear forces can be determined from the velocity profile obtained using HC.

Non-uniform flows of the kind depicted in FIG. 10 exert shear forces that can distort or even denature proteins The amount of shear is quantified by the strain rate, y=dv/dz. Some proteins show signs of shear-induced changes at strain rates as low as y=100 s⁻¹. Thus, certain embodiments of holographic characterization show changes in protein distributions with shear forces induced prior to measurement. Others appear to be stable at strain rates exceeding 10⁵ s⁻¹. Strain-induced transformations have known biological functions, and are implicated in some disease states. Functional consequences of flow-induced shear have obvious implications for capillary-based delivery of biopharmaceuticals. They also may influence results obtained by methods described herein.

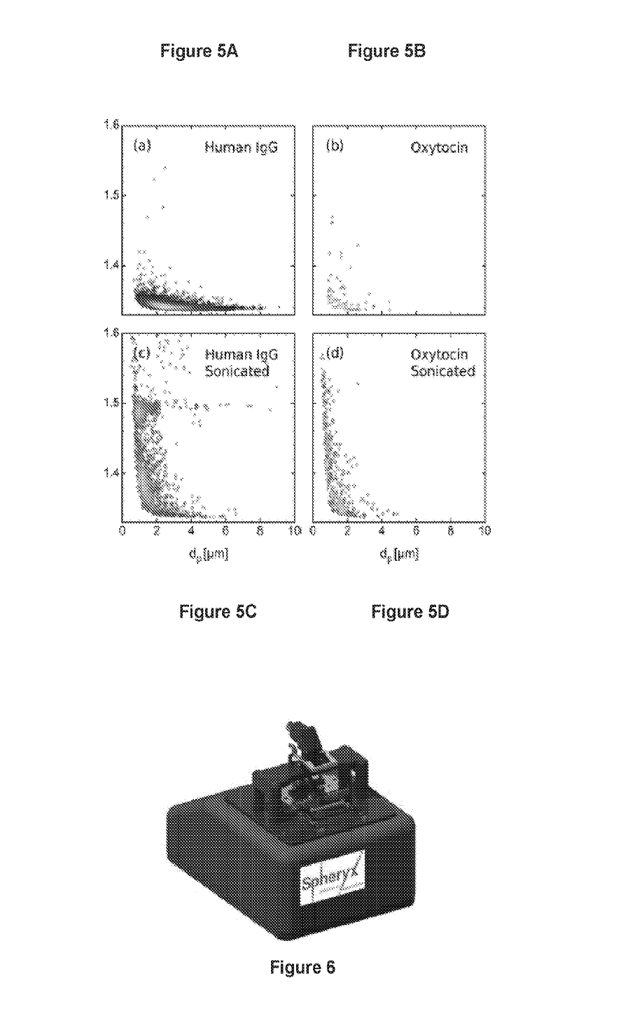

Shear forces can promote protein aggregation, both by distorting individual proteins and also by increasing the rate and force of inter-particle collisions. Conversely, shear forces can distort protein aggregates or even disaggregate them. These factors can conceivably change the concentration, size distribution and apparent morphology of protein aggregates in suspension. Such changes are evident in the holographic characterization data in FIG. 5, in which shear forces were generated by sonication.

The maximum strain rate encountered in certain embodiments of microfluidic channels depends on the channel's height, H, and the midplane flow speed, v₀, as #′=4v₀/H. With planned channel heights ranging from 50 μm to 100 μm, shear forces might possibly influence observed aggregation behavior, particularly at flow speeds substantially in excess of 1 mm s⁻¹.

Model systems will include standard sets of protein aggregates and well-characterized fractal aggregates composed of colloidal particles. Thus, in one embodiment, holographic characterization (HC), can be used as a powerful tool for assaying shear-induced transformations in protein suspensions, an area of active research that will benefit from the wealth of holographic characterization data. At the same time, they will establish the range of operating parameters for HC that optimize measurement speed without compromising reliability and reproducibility.

As discussed above, there are a number of particles that exhibit irregular, even fractal, shapes which present issues for traditional holographic microscopy analysis. In one embodiment, HMC can provide further ability to distinguish nonspherical particles, such as irregular materials like protein aggregates from near spherical particles such as regular shaped contaminants, for example, but not limited to silicone oil, air bubbles, and other contaminants with near spherical symmetry. In one embodiment, Hu moment analysis provides an objective and quantitative comparison, such that the system can provide automatic distinction of spherical and non-spherical species. In another embodiment, methods and systems can utilize the Hu moment analysis to identify specific structures with different 3D geometrical shapes. Hu moments may provide distinction of these kinds of different geometrical shapes, beyond spheres and non-spheres. The quantitative magnitudes of the Hu moments will be specific to each application and will depend on the shapes involved. In addition, this analysis can be used beyond proteins into other fields, such as identifying different contaminants in all manner of samples, such as water quality measurements, chemical mechanical polishing slurries, or nanoparticle samples including specific, nanostructures such as nanorods. HMC accomplishes this distinguishing by image analysis of particle holograms. As described herein, the reference will be made to an illustrative embodiment of protein aggregates as the irregular material (i.e., the desired material, product, etc.) and to silicon oil emulsion droplets as the regular material (i.e. the contaminate).

Silicone oil emulsion droplets tend be circular and thus tend to have circularly symmetric holograms. In contrast, protein aggregates can have branched or filamentary structures. These differences in structure lead to differences in the holograms that can be used to distinguish these two types of particles. This is important for being able to distinguish protein aggregates from silicone oil emulsion droplets which have the same size and refractive index. Although most protein aggregates have different refractive index than silicone oil, there can be overlap in there distributions. For example sonicated Human IgG protein contains some protein aggregates slightly smaller than 1 μm which have refractive index around 1.41 which is the same as silicone oil. Thus, refractive index cannot be relied upon and there is need for further analysis using differences between the holograms to distinguish these particles.

In one embodiment, systems and methods for HMC utilize key differences between the holograms of protein aggregates and silicone oil emulsion droplets to differentiate the two.

The most significant difference shows up in the image moments. Image moments are summary statistics about the image that describe the distribution of intensity throughout the image, typically of a certain particular weighted average. In some embodiments, invariants with respect to translation, scale, and rotation are constructed and utilized. So called “Hu's moments” (or Hu's invariant moments or Hu's invariants) have rotation, translation, and scale invariance, and thus are good for describing holograms which come in different sizes and orientations as particles flow through the microfluidic channel. In particular, the first Hu moment is different between irregular particles (protein aggregates) and regular particles (silicone oil droplets). It is zero for perfectly circularly symmetric holograms and so is very small for silicone oil droplets while it tends to be larger for the less symmetric protein aggregates. By computing the Hu's moment for each detected feature (using HMC), the relevant moments can be calculated and used to identify the features and the corresponding particle, such as identifying silicone oil droplets and proteins.

To maximize the distinguishing capability of the Hu moment, the hologram can first be converted into a binary image. Binary images greatly enhance the contrast, simplifying the identification of the shape.

Robust determination of the threshold to create the binary image optimizes the representative image of the hologram. If the threshold is too low detail is lost and the image appears predominantly white. Similarly, if the threshold is too high the image is predominantly black and again detail is lost.

Bilateral filters can be used to smooth the hologram and reduce the chance of a few intense pixels biasing the results. After the smoothing, thresholds are determined for the hologram proportionally to its largest values.

In the binary image, noise can create spurious shape information. To eliminate or reduce these artifacts, dilation and erosion is used during image processing. In the erosion step, a predetermined number of white pixels are removed around any island of white pixels. During dilation a border of white pixels are added around any island of white pixels. Very small islands of white pixels in the image are removed completely in the erosion step, while larger shapes are restored with smoothed edges.

Another important but more sensitive quantity is the azimuthal standard deviation or the variation in image intensity around the center of the image. In some embodiments, the azimuthal standard deviation or variation in image intensity is considered. In the case of silicone and protein materials, this is much smaller for silicone oil than for protein aggregates, however it is sensitive to the level of noise in the image. The Hu's moments and azimuthal standard deviation may be used alone or in combination to identify features in a hologram and, ultimately, to identify particles in a sample.

In a further embodiment, a deconvolution procedure is utilized to take advantage of the multi-dimensional size and refractive index distribution given by HMC to distinguish particles. Silicone oil emulsion droplets have refractive indices that match the bulk refractive index of silicone oil. In contrast protein aggregates have refractive indices which depend on the size of the aggregates. Larger protein aggregates have lower effective refractive index because their branched structure is filled with the fluid medium. The measured refractive index is an effective refractive index of the mixture the fluid and protein in the protein aggregate which is described by Maxwell Garnett theory. The different shape of these distributions in size and refractive index allows us to separate them even when they have overlap. Thus, in one embodiment, each distribution can be described separately so as to allow deconvolution when they are mixed together.

Total Holographic Characterization offers advantages over established particle-characterization techniques. It is inherently self-calibrated, requiring as inputs only the wavelength of the imaging laser, the refractive index of the medium and the optical magnification. Its workflow lends itself to automation, and contrasts with techniques such as Coulter counters and fluorescence microscopy that require sample preparation by trained personnel. Holographic characterization offers better size resolution than particle-resolved imaging techniques such as optical microscopy, light obscuration and micro-flow imaging. In one embodiment, particles can be resolved to within nanometers. Unlike bulk characterization techniques such as dynamic light scattering (DLS), Total Holographic Characterization seamlessly handles inhomogeneous and polydisperse samples, and yields consistent results independent of concentration. In differentiating aggregates from contaminants, Total Holographic Characterization has the advantage of generality over the resonant mass measurement (RMM) technique, which can only differentiate contaminants by the sign of their buoyant mass. The high-resolution three-dimensional tracking capabilities of Total Holographic Characterization also can be used for nanoparticle tracking analysis (NTA), which offers complementary measurements of individual objects' hydrodynamic sizes.

The ability to monitor content of a system and distinguish irregular particles from regular particles provides many useful applications. FIGS. 4 and 5 illustrate the ability of Total Holographic Characterization to monitor trends in protein aggregation induced by changes in pH, and application of ultrasound. The representative data presented in FIG. 4 show the influence of pH on aggregation in oxytocin. Increasing the pH from 2.0 (FIG. 4A) to 9.0 (FIG. 4B) increases the concentration of subvisible aggregates after 1 h by a factor of 10. This trend is summarized in FIG. 4C. Although the number of aggregates varies substantially with pH in these experiments, the mean aggregate size and the shape of the distribution of size and refractive index remain constant. Changing pH therefore appears to change the rate of aggregation in this system without greatly affecting growth morphology.

FIG. 5 reveals that sonication has a qualitatively different influence on protein aggregation. The data in FIGS. 5A and 5B show holographic characterization results for solutions of human IgG and oxytocin, respectively, both prepared under conditions conducive to aggregation. The detected aggregates have diameters extending to 10 μm and low refractive indexes characteristic of open branched structures. Each of these samples was then subjected to 1 h of mechanical agitation by ultrasound in a standard bath sonicator. In both cases, sonication appears to disrupt the largest aggregates, promoting instead a population of smaller diameter clusters with substantially higher refractive indexes. Results for human IgG are plotted in FIG. 5C, and those for oxytocin in FIG. 5D. Because refractive index is a proxy for density, protein aggregates in the sonicated samples appear to be more compact. It is possible that these dense objects originally were bound into the larger open aggregates, and were simply separated by sonication. It also is possible that sonication restructures existing open aggregates into dense structures. This could well be the explanation for the increased number of small dense objects in oxytocin after sonication.

In establishing optimal flow speeds for fast sample analysis, one embodiment utilizes the camera's exposure time to impact the precision and accuracy of holographic characterization measurements. Holographic images of colloidal particles become blurred if the particles move substantially during the camera's exposure time. Motion blurring, in turn, can influence the results of holographic characterization. Blurring and its associated artifacts can be minimized by reducing the camera's exposure time. Short exposures, however, suffer from poor signal-to-noise ratio, and thus reduce precision. Higher flow rates enable the measurements of higher density particles that can settle out of the flow at lower flow rates. In on embodiment, HC measurements are made up to a linear sample flow speed of 6 mm/sec in flow, in one embodiment, at least 6 mm/sec and a camera exposure time of 0.05 msec.

The three-dimensional tracking data obtained from Total Holographic Characterization can be used to locate particles in the observation volume, and to identify the same particle in consecutive video frames. The resulting sequence of particle locations can be linked into single-particle trajectories. Each point on a particle's trajectory through the observation volume is associated with an independent estimate of the particle's size and refractive index. These can be combined to improve accuracy and precision. All of the characterization data presented in this proposal were obtained using tracking.

Particle tracking also helps to ensure that every particle passing though the observation volume is detected and analyzed, even if particles pass close enough to obscure each other. The tracking algorithm can identify and correct for collisions, even if the particles cannot be individually identified during part of their transit. Tracking is essential for obtaining the accurate particle counts required for accurate concentration measurements. However, increasing flow speed reduces the time each particle spends in the observation volume. Tracking each particle through multiple video frames requires increasing the frame rate of the camera, which can increase the manufacturing cost of the instrument.

In one embodiment, problems anticipated for accelerated holographic characterization might be mitigated by reducing the magnification of the holographic microscope, thereby increasing the field of view. Particles will take more time traversing this larger observation volume, and thus will be recorded in more frames, relaxing the requirement for recording at higher frame rates. The larger lateral dimension will further increase the number of particles that will be observed and characterized during the measurement period. Reducing magnification also will lower the manufacturing cost of the instrument.

However, a complication of switching to a lower-magnification objective lens is the reduction of spatial resolution in the recorded holograms. Although smaller holograms can be analyzed more rapidly, the loss of spatial resolution might diminish the reliability of numerical fits to the Lorenz-Mie scattering theory. Lower-magnification lenses also tend to have lower numerical apertures, which might further blur holograms and hinder analysis. In one embodiment, the magnification of the objective lens is reduced, such as from 100× to 40× with the goal of maintaining accuracy while increasing analysis speed and reducing instrument cost.

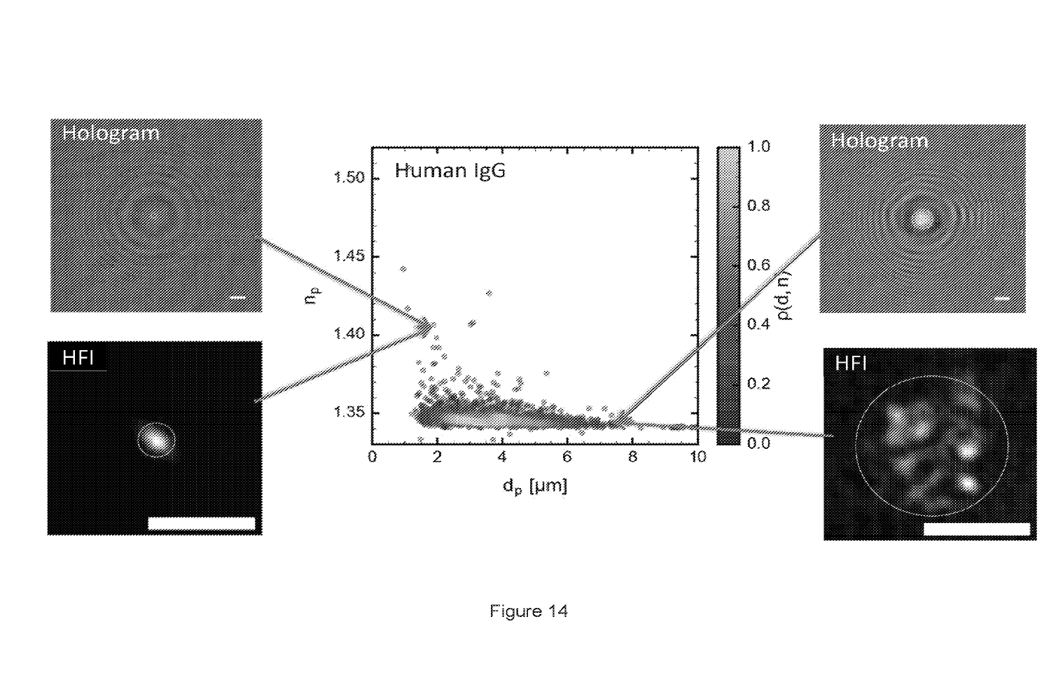

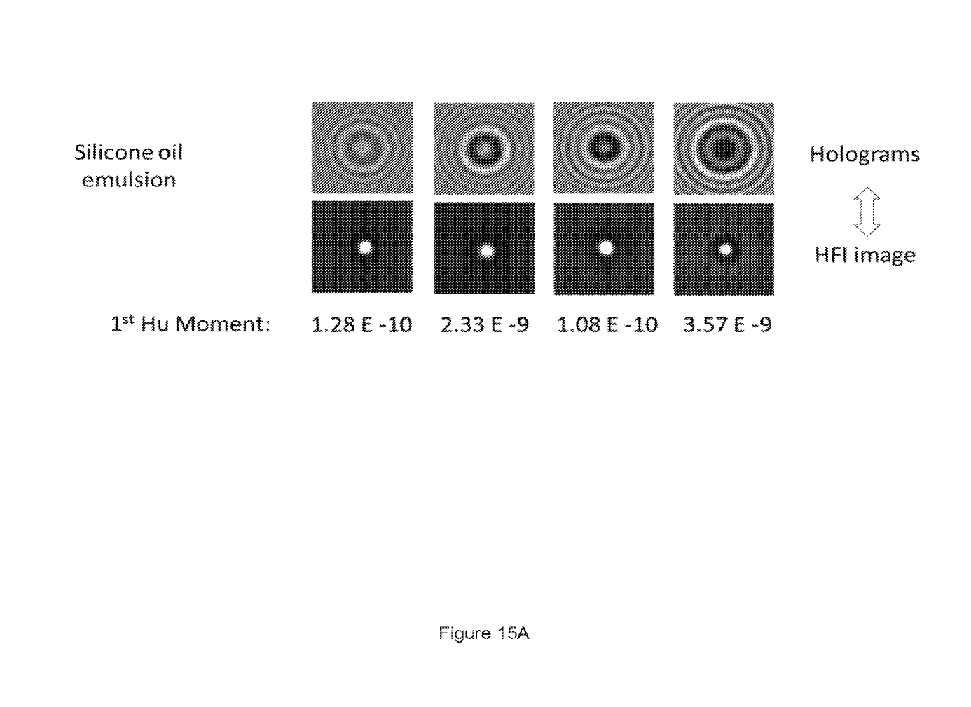

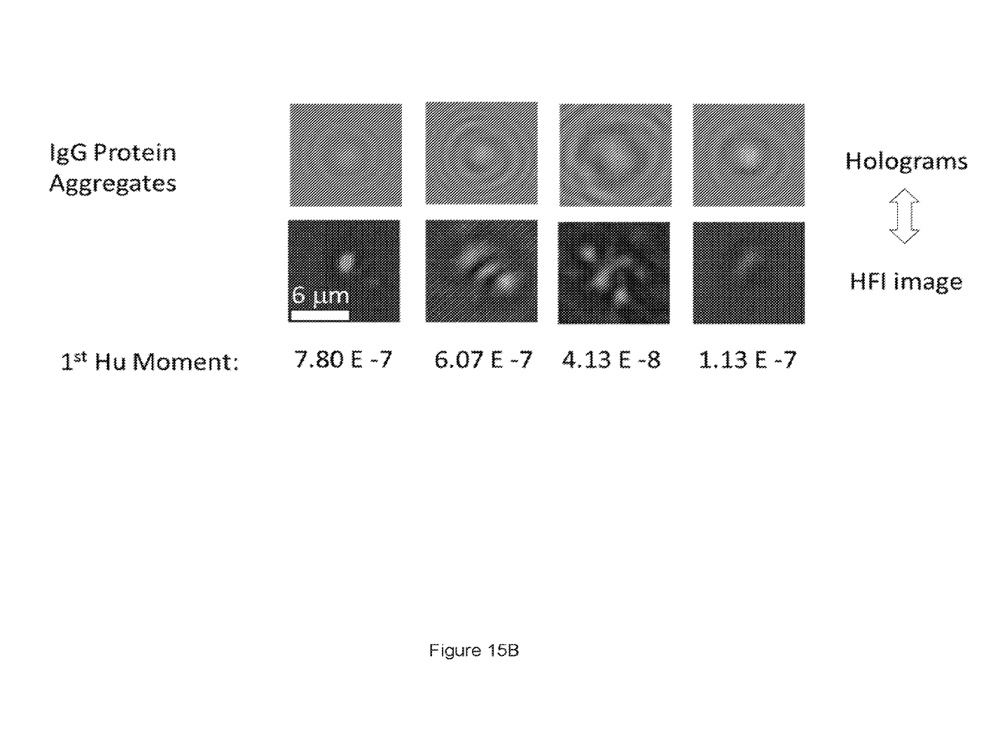

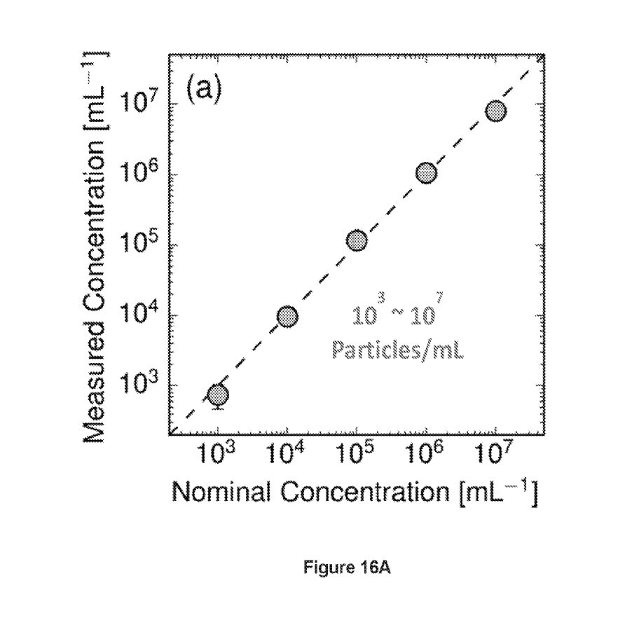

While holograms and the techniques described above with regard to HMC provide both useful data and provide a visual image, i.e. a hologram, there is a desire to have a visual image that is more familiar and readily comparable to known experiences of a lay person. Thus, in one embodiment, a holographic flow image, essentially a hologram based brightfield representation, is created. These holographic flow images, for example as seen in FIG. 14, are similar in nature to bright field photographs that most laypersons would be familiar with. FIGS. 15A and 15B demonstrate the more readily discernable differences between HFI images of a protein aggregate particle (15B) compared to a silicone droplet (15A).

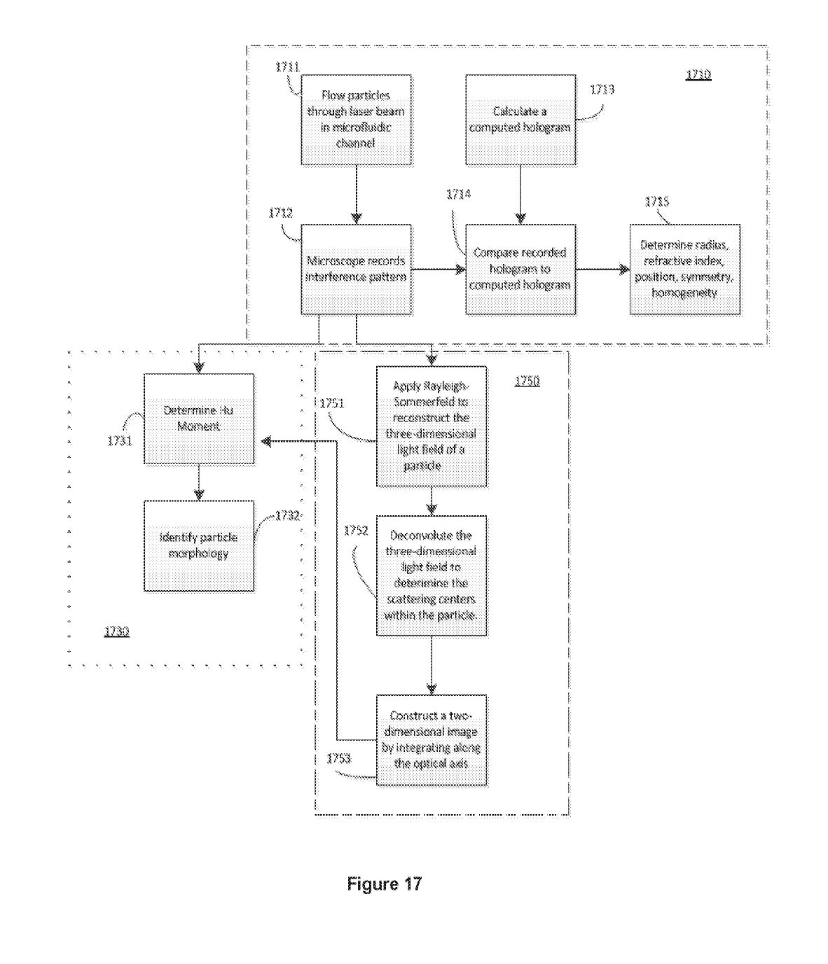

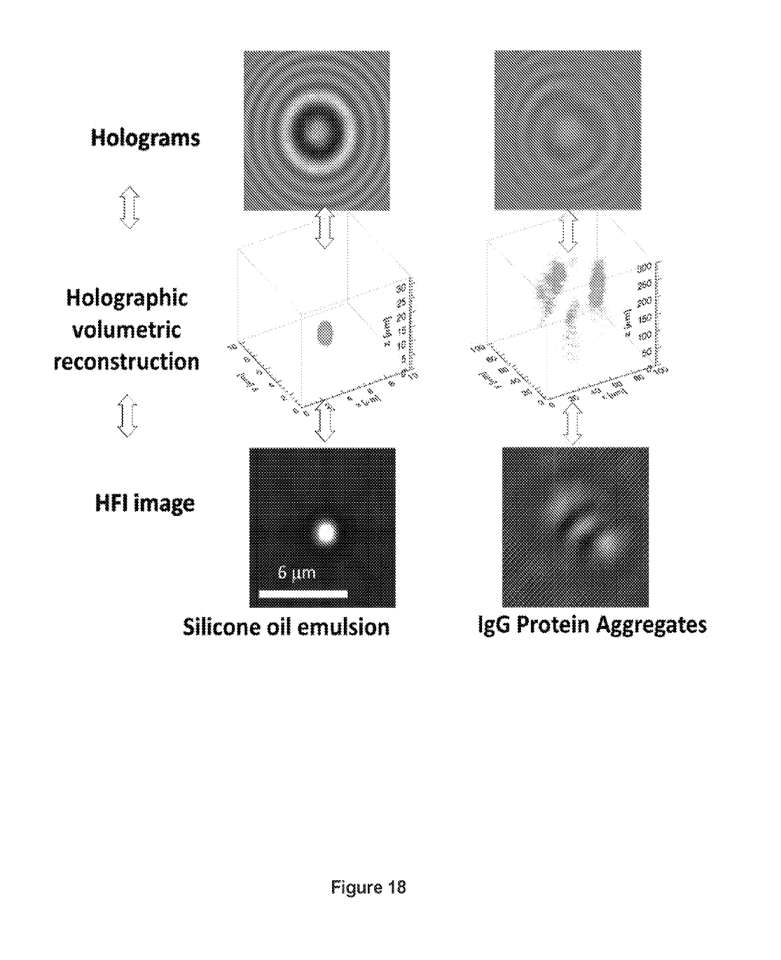

In some embodiments a hologram or holograms are used to generate bright field representations of particles. FIG. 17 illustrates one embodiment and demonstrates the interplay between HMC resulting in property determinations (collectively steps 1710) and the process to create a HFI (1750) and identify particle morphology by Hu Moment (1730). Rayleigh-Sommerfeld theory can be used to reconstruct (1751) the 3D light field created by a scattering particle from the hologram captured by HMC (1710). From the 3D light field, the positions of all of the scattering centers within the particle are determined, using deconvolution methods (1752). The scattering centers are used to construct the 3D structure of the particle. Numerical Integration along the optical axis creates a 2D image that is an accurate representation of a bright field image (1753). In FIG. 18, there are 2 holograms on the top row representing particles with two different shapes. R-S reconstruction and deconvolution is used to determine the 3D structures that are presented in the second row. Integration along the optical axis results in the 2D HFI images presented in the bottom row. HFI images can also be calculated by integration along any other axis of the 3D structure as well. Integration along the optical axis is most comparable to data acquired with bright field microscopy.

3D reconstruction with deconvolution followed by integration along one axis results in higher resolution images than is possible for traditional bright field images of sub-visible particles. In one embodiment, holographic characterization uses imaging optics with a high numerical aperture and with a narrow depth of field. However, HC measures holograms of the particles, which does not require that the particles be in the focal plane. In fact, particles are measured located over a large distance from the focal plane while maintaining high resolution. In practice, particles can be 100s of μm from the focal plane while maintaining high resolution. In contrast, in bright field microscopy, particles must be located within the depth of field of the focal plane. In practice, if particles are even slight distances from the focal plane (a few μm) they will be out of focus. In bright field microscopy, if the particle is large with respect to the depth of field, then the entire image will not be simultaneously in focus. In contrast, in HFI images, constructed from HC holograms, particles larger than the depth of field will be completely in focus, because the hologram is not measured in the focal plane. As an example, a numerical aperture of 0.75 provides 0.35 μm resolution in an HFI image or bright field image. HFI has an effective depth of field 100 s μm, while bright field microscopy has a depth of field of about 1 μm.

Images from HFI can be quantified with Hu moment analysis (1731) to determine the shape and quantitatively measure the deviation of the particle from spherical symmetry, i.e. to identify particle morphology (1732). The Hu moment quantification can proceed from the hologram (from step 1712) and/or from the bright-field image (Step 1753).

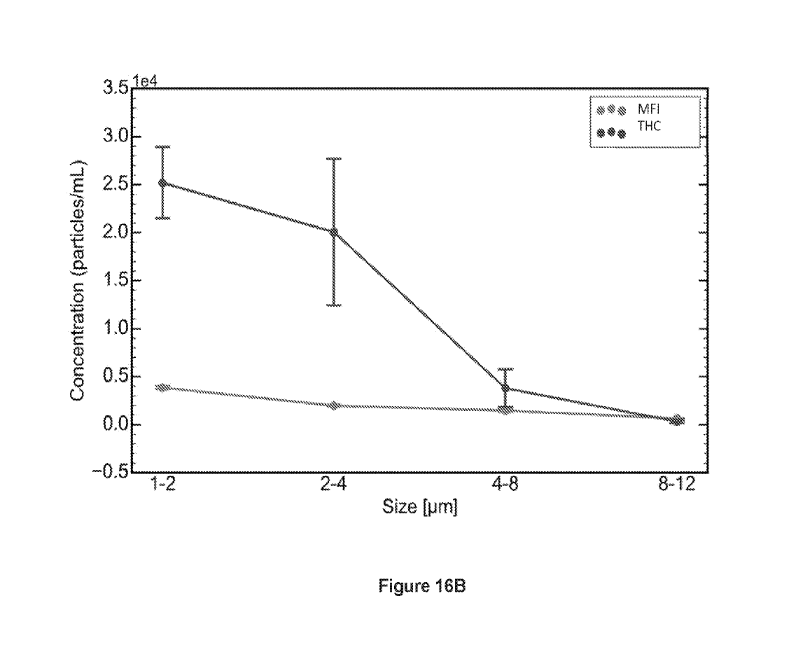

While traditional bright field microscopy relies upon high magnification to capture images of sub-visible particles, such comes at the cost of depth of field. Such bright field images have a very shallow depth of field. In contrast, HFI is fast and accurate with large depth of field. The shallow depth of field limits the amount of detail that is possible to capture in a bright field image. Current microflow imaging techniques use low magnification and small numerical apertures that cannot give the high resolution images possible in HFI. The limitations in the resolution due to the small depth of field decreases the sensitivity of detection for microflow imaging especially for small particles. Accurate particle counts are required to make accurate measurements of concentration. Decreased sensitivity in detection, leads to inaccuracies in concentrations for smaller particles. HC and HFI, as an extension of HC, has higher sensitivity in detecting smaller particles and results in more accurate concentration measurements for smaller particles (see FIG. 16A).

The holograms captured by HFI encode the 3D information which are digitally reconstructed to form detailed bright images even when the particles are not in the focal plane. In fact, holograms measured by HMC are not in the focal plane of measurement.

HFI requires a single image, a hologram, to numerically generate a high resolution 2D image which represents the entire 3D structure of the particle, whereas a brightfield microscopy image capture only a slice of the particle at a narrow region at the focal plane of the brightfield microscope. The high resolution of the HFI image facilitates Hu moment analysis of the symmetry of particles

Applications of HFI and image analysis, both independently and applied together, include but are not limited to protein aggregates, polishing slurry agglomerates, large particle contaminants in nanoparticle mixtures, and non-spherical contaminants of any kind suspended in fluids.

The speed and quantitative aspects of HFI and Hu moment analysis, both independently and applied together are applicable to quality control, quality assurance, and manufacturing process control. In manufacturing, the mechanism of formation of aggregates can be critical to preventing aggregation. Morphology can be an important source of information about aggregation mechanism. In formulation, prevention of aggregation is a critical goal. Thus, knowing the morphology from HFI and/or Hu moment analysis can inform the determination of the mechanism which helps to create formulations that will prevent aggregation.

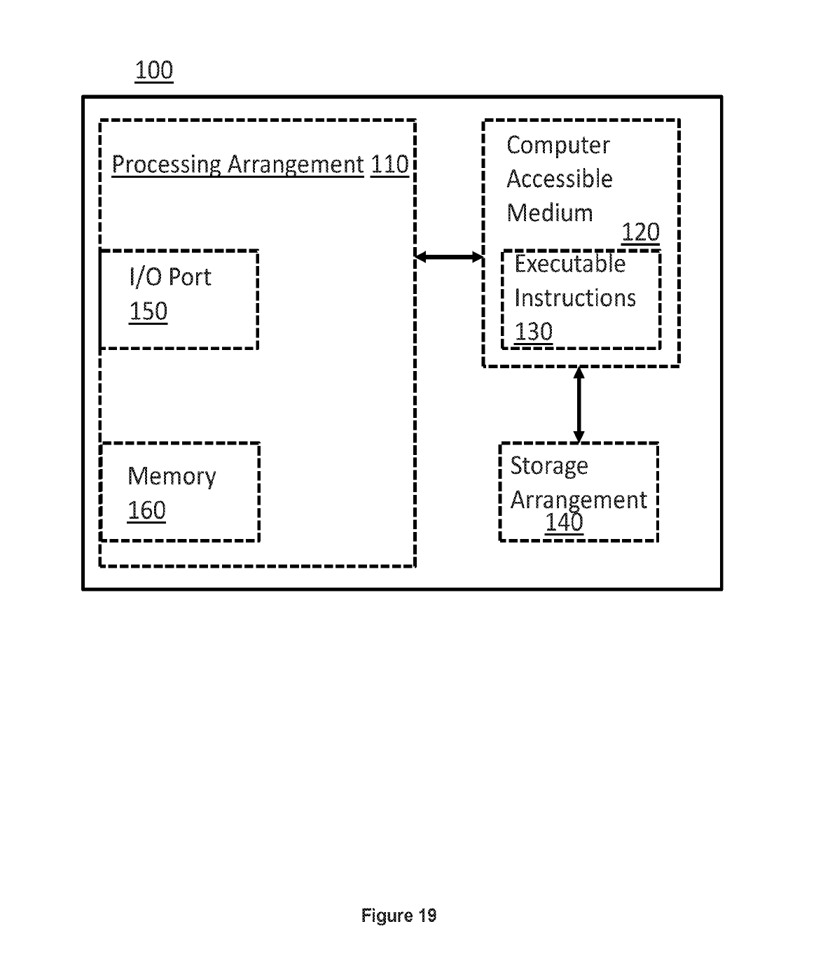

As shown in FIG. 19, e.g., a computer-accessible medium 120 (e.g., as described herein, a storage device such as a hard disk, floppy disk, memory stick, CD-ROM, RAM, ROM, etc., or a collection thereof) can be provided (e.g., in communication with the processing arrangement 110). The computer-accessible medium 120 may be a non-transitory computer-accessible medium. The computer-accessible medium 120 can contain executable instructions 130 thereon. In addition or alternatively, a storage arrangement 140 can be provided separately from the computer-accessible medium 120, which can provide the instructions to the processing arrangement 110 so as to configure the processing arrangement to execute certain exemplary procedures, processes and methods, as described herein, for example. The instructions may include a plurality of sets of instructions. For example, in some implementations, the instructions may include instructions for applying radio frequency energy in a plurality of sequence blocks to a volume, where each of the sequence blocks includes at least a first stage. The instructions may further include instructions for repeating the first stage successively until magnetization at a beginning of each of the sequence blocks is stable, instructions for concatenating a plurality of imaging segments, which correspond to the plurality of sequence blocks, into a single continuous imaging segment, and instructions for encoding at least one relaxation parameter into the single continuous imaging segment.

System 100 may also include a display or output device, an input device such as a key-board, mouse, touch screen or other input device, and may be connected to additional systems via a logical network. Many of the embodiments described herein may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art can appreciate that such network computing environments can typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Various embodiments are described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, are intended to encompass implementations using one or more lines of software code, and/or hardware implementations, and/or equipment for receiving manual inputs.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. Therefore, the above embodiments should not be taken as limiting the scope of the invention.

1. A method of determining a particle's morphology, comprising:
flowing a particle through a laser beam in a microfluidic channel;
recording an interference pattern of the laser beam and the particle;
reconstructing a three-dimensional light field by applying Rayleigh-Sommerfeld analysis;
deconvoluting the three-dimensional light field to determine scattering centers within the particle;
integrating along a single axis and constructing a two-dimensional image of the particle.

2. The method of claim 1 further comprising determining Hu moments for the image.

3. The method of claim 1, further comprising identifying the morphology of the particle.

4. The method of claim 1, further comprising calculating a computed hologram and comparing the computed hologram to the recorded interference pattern.

5. The method of claim 1, wherein a computed hologram is computed by Lorenz-Mie theory.

6. The method of claim 5, further comprising determining at least one of radius, refractive index, symmetry, and homogeneity.

7. The method of claim 1, wherein a plurality of particles are flowed through the laser beam and a two-dimensional image is constructed for a plurality of particles.

8. A method for determining a particle's morphology, comprising:
flowing a sample through a microfluidic channel;
interacting a laser beam with the sample;
scattering the laser beam off the sample to generate a scattered portion;
generating an interference pattern from an unscattered portion of a collimated laser beam and the scattered portion;
magnifying the interference pattern with an objective lens;
recording the interference pattern for subsequent analysis;
applying a scattering function to calculate a hologram and fitting the recorded interference pattern to the calculated hologram;
determining an estimate of the specimen's refractive index and radius from the fitted calculated hologram; and
determining Hu moments for the recorded interference pattern.

9. The method of claim 8, further comprising generating a brightfield image by:
reconstructing a three-dimensional light field by applying Rayleigh-Sommerfeld analysis;
deconvoluting the three-dimensional light field to determine scattering centers within the particle; and
integrating along a single axis and constructing a two-dimensional image of the particle.

10. The method of claim 9, further comprising identifying the morphology of the particle.

11. The method of claim 9, further comprising calculating a computed hologram and comparing the computed hologram to the recorded interference pattern.

12. The method of claim 9, wherein the computed hologram is computed by Lorenz-Mie theory.

13. The method of claim 12, further comprising determining at least one of radius, refractive index, symmetry, and homogeneity.

14. The method of claim 9, wherein a plurality of particles are flowed through the laser beam and a two-dimensional image is constructed for a plurality of particles.

15. The method of claim 9, wherein flowing the sample is at a speed of at least 6 mm/sec.

16. The method of claim 9, further comprising determining shear forces for the sample.

17. The method of claim 9, wherein the single axis is an optical axis of the objective lens.

18. A computer-implemented machine for determining a particle's morphology comprising:
a processor;
a holographic microscopy system;
a sample stage for receiving and flowing a plurality of particles; and
a tangible computer-readable medium operatively connected to the processor and the holographic microscopy system and including computer code configured to:
flow a particle through a laser beam in a microfluidic channel in the sample stage;
record an interference pattern of the laser beam and the particle;
reconstruct a three-dimensional light field Applying Rayleigh-Sommerfeld analysis;
deconvolute the three-dimensional light field to determine scattering centers within the particle; and
integrate along a single axis and constructing a two-dimensional image of the particle.

19. The machine of claim 18, wherein the sample stage comprises a carousel cartridge.

20. The machine of claim 18, wherein the microfluidic channel is 50 μm×1000 μm.
